(19) United States
(12) Patent Application Publication
(10) Pub. No.: US 2006/0246200 A1
(43) Pub. Date: Nov. 2, 2006

(54) Hydroxyapatite in aqueous solution for bone health

(76) Inventor: Rifat Parvez, Skillman, NJ (US)

Correspondence Address: MATHEWS, SHEPHERD, MCKAY, & BRUNEAU, P.A., 29 THANT ROAD, SUITE 201, PRINCETON, NJ, 08540, US

(21) Appl. No.: 11/476,526

(22) Filed: Jun. 28, 2006

Related U.S. Application Data
(63) Continuation-in-part of application No. 10/425,093, filed on Apr. 28, 2003.

(51) Int. Cl. A23L 2/00

(52) U.S. Cl. 426/590

(57) ABSTRACT

Glycine phosphate (phosphoglycine) and glycine citrate (citroglycine) are used in solubilizing carbonate salts of calcium and optionally zinc in water. Stoichiometric proportions of these ingredients when added to water cause an effervescent reaction that results in an aqueous solution containing completely solubilized and bioavailable calcium phosphate (hydroxyapatite), calcium hydrogen citrate, glycine and optionally, zinc citrate. The aqueous solution of this invention, after addition of suitable flavor(s), sweetener(s), acidulent(s), other nutritional and/or herbal ingredients can be added to the aqueous solvent. The resultant solvent provides a clear aqueous beverage including completely absorbable bone minerals for maintaining bone density and strength and to prevent osteoporosis. The beverage of the present invention can be used as a substitute for plain bottled water, sodas, and the like, and as a substitute for people who are allergic to milk.

### CROSS REFERENCE TO RELATED APPLICATION

This application is a continuation-in-part of U.S. patent application Ser. No. 10/425,093 filed Apr. 28, 2003, the entirety of which is hereby incorporated by reference into this application.

### FIELD OF INVENTION

The present invention is concerned with providing completely solubilized hydroxyapatite (calcium phosphate) and zinc citrate in water in order to enhance their bioavailability and absorption. More particularly, the present invention provides completely solubilized hydroxyapatite (calcium phosphate) and zinc citrate, in a clear water beverage from which calcium, phosphorus and zinc all in ionized form, are completely bioavailable immediately after ingestion.

### BACKGROUND OF THE INVENTION

Calcium is an essential mineral with a wide range of biological actions. Apart from being a major component of bones and teeth, calcium is crucial for muscle contraction, nerve conduction, beating of the heart, blood coagulation, glandular secretion, energy production and the maintenance of immune function.

Calcium exists in bones and teeth primarily as hydroxyapatite (calcium phosphate). Almost 99% of the total body calcium is found in bones and teeth.

Calcium has anti-osteoporotic activity as well as anti-carcinogenic, anti-hypertension and hypocholesterolemic functions. A number of studies also suggest that calcium may reduce the risk of colorectal cancer (N. Engl J Med. 1993; 313:1381-1384, N. Engl J Med. 1999; 340:101-107). Calcium supplementation has been shown to have a modest affect on the reduction of systolic blood pressure in people with hypertension (Ann. Intern. Med. 1996; 124:825-831, Arch. Fam. Med. 2000; 9:31-39). Still other studies have found calcium supplementation to lower serum cholesterol levels (Arch. Fam. Med. 1992; 152:2441-2444).

In findings by the Heritage Family Study, it is reported that calcium deficiency leads to abdominal adiposity. Another study reported that obese people on a 24-week, low calorie diet who received 800 mg of calcium per day lost more weight than those on placebo (Vitamin Retailer February 2005).

The absorption of calcium varies throughout the life span, being highest during infancy and decreasing during adulthood. In post-menopausal women, fractional absorption of calcium declines about 0.21% annually.

Absorption efficiency varies with different calcium salts and complexes, being about 35% for calcium citate and 29% from milk. In a study using radio-labeled calcium, it has been shown that the absorption efficiency (measured as bone deposition) for calcium sulfate was 49%, for calcium phosphate was 31% and for calcium carbonate was 30%. All these calcium salts were administered as tablets.

The inefficiency of calcium absorption has been recently highlighted by The New England Journal of Medicine. It reported very little difference in the fracture rate of women who have been taking calcium supplements for seven years. This Women's Health Initiative study involved 36,000+women over a seven-year period.

The combination of calcium and phosphorus is optimal for healthy bone development. The medical community has for a long time known the benefits of calcium for healthy bones and soft tissues and has now shown that the mineral phosphorus also plays an equally important role (Ann. Rev. Nutr. 1988; 8:121-148).

Researchers at Creighton University Medical Center in Omaha, Nebr. conducted a study to determine the role of phosphorus in bone growth and development. They were able to demonstrate the consequences of phosphorus deficiency and the co-dependence on calcium and phosphorus for bone growth. They concluded that in any growth situation, both calcium and phosphorus are needed to support an increase in bone mass. (Bone 32 (2003), 532-540).

Phosphorus intake in a normal diet is usually sufficient to meet standard nutritional guidelines. However, phosphorus deficiencies are prevalent. Phosphorus deficiency is generally treated with phosphorus supplements such as calcium phosphate.

Phosphorus is an integral part of many organic compounds and plays an important role in energy and protein metabolism. Phosphorus is a component of adenosine triphosphate (ATP), a fundamental energy source in living things. Almost every biochemical reaction that occurs within the human body involves phosphorus. It is found in complex organic compounds in the blood, muscles, nerves and in calcium phosphate (hydroxyapatite), the principal material that gives rigidity and strength to bone and teeth (Int. J. Sport Nutr. 1992; 2:20-47).

Zinc is also an important element in human and animal nutrition. Zinc possesses catalytic, structural and regulatory roles in the more than 200 zinc metalloenzymes previously identified in biological systems. Metalloenzymes are mainly involved in nucleic acid and protein metabolism and the production of energy. Zinc also plays a structural role in the formation of so-called zinc fingers, which are exploited by transcription factors for interacting with DNA and regulating the activity of genes (Science 1996; 271-108 1-1085). Additionally zinc is involved in the maintenance of the integrity of biological membranes and guards against oxidative injury.

Zinc is present in all of the body organs, tissues, fluids and secretions. Zinc is vital for growth and development, sexual maturation and reproduction, dark vision adaptation, olfactory and gustatory activity, insulin storage and for a variety of host immune defenses (J. Nutr. 2000; 130 (5S Suppl); 1378S-1383S). Publicized claims that zinc is efficacious in preventing and ameliorating symptoms of the common cold are also supported by Nutrition Reviews (Nutr Rev. 1988; 106:192-198).

Additionally, research suggests that iron and zinc stores are important not just in performance but also exercise-related health problems. Researchers report that exercise-induced menstrual dysfunction may be due to different levels of iron and zinc, both of which adversely affect bone health.

Nutritional supplement products containing calcium have been and continue to be available mostly in solid dosage formulations. However, of late calcium as different calcium salts but primarily calcium carbonate have been added to fortify beverages, yogurts, milks, and other foods. The required daily amount of elemental calcium is 1000 mg for adults and children over 4 years. Each calcium supplement tablet provides up to about one-half of the required daily amount. These tablets are usually large and hard to swallow. Consumers, especially older women and children, usually avoid such large tablets or take them with difficulty. Chewable forms available leave a gritty, chalky mouthfeel. The size of the tablet is dictated by the calcium salts used and marketing constraints that demand fewest tablets to be taken per day. The amount of elemental calcium available is highest in calcium carbonate at 40% and lowest in calcium gluconate at 9.3%. Calcium carbonate is the primary source of calcium in almost all supplements, fortified foods and beverages because of cost considerations and its highest elemental calcium content.

As described above, phosphorus is almost always present as calcium phosphate, which is essentially used as a delivery form of calcium or as a filler/binder in making tablets. The phosphorus content of calcium phosphate is about 25%. The required daily amount of phosphorus is 1000 mg. The amount of phosphorus available from calcium phosphate that is used as filler/binder does not exceed 250 mg. Therefore, while the required daily amount of calcium (1000 mg) is provided by 3-4 tablets, same is not true for phosphorus.

Zinc is available in a host of nutritional products. It is present in almost all multivitamin/mineral formulations, in tablets with calcium and magnesium and as lozenges. Dosage contents vary from 5 mg to 50 mg. The required daily amount of zinc is 15 mg.

As described above, the absorption of calcium from solid forms varies between 30% and 50%, being about 30% from calcium carbonate which is the primary source of calcium. Therefore, even though 3-4 tablets supplying 1000 mg of elemental calcium may be used, the total amount dissolved and available for absorption is at best 300-500 mg. In order to obtain the full amount of daily requirement of calcium, it is necessary to (1) increase the number of tablets to more than 15 per day or (2) increase the bioavailability/absorption of calcium. Since it is not practical to take 15 or more supplement tablets daily and technology does not exist to significantly increase the bioavailability and absorption of calcium from existing formulations, the present invention provides the method of solubilizing and the method of delivering completely bioavailable and absorbable bone minerals.

Many attempts have been made at increasing the solubility of calcium from solid forms.

U.S. Pat. No. 5,151,274 describes nutritional improvements in calcium supplements that can be used in conjunction with foods and beverages or taken as an oral solid or liquid supplement. Mineral calcium citrate malate in powder form is used in tablets, capsules, granules and bulk powders or added to a juice-containing beverage or other beverages. The solubility and absorption of calcium from calcium citrate malate powder is limited.

U.S. Pat. No. 3,949,098 describes a nutritious orange drink concentrate that contains whey protein. The patent suggests other nutrients which include various cupric salts, manganese salts, zinc salts, as well as calcium salts.

U.S. Pat. No. 4,497,800 describes a nutritionally complete ready-to-use liquid diet for providing total patient nourishment. The diet contains free amino acids, and small peptides, a carbohydrate source and nutritionally significant amounts of all essential vitamins and minerals and stabilizers. The minerals include calcium, copper, zinc and manganese, among others. Most of these minerals are given as a gluconate salt.

U.S. Pat. No. 4,214,996 discloses dispersible mineral compositions. These compositions contain calcium, phosphorus, zinc as well as manganese, as powders.

U.S. Pat. No. 6,235,322 discloses mineral compositions that have been mixed in solution with an acid, solubilized at high concentrations, dried and ground. Powdered mineral salts are thus formed which can be reconstituted in various vehicles. This patent teaches that compositions of calcium alone with acids were tried and they failed. The calcium fell out of solution within a short time.

It is known that salts of calcium alone formed with food grade acids such as, but not limited to, phosphoric acid, lactic acid, citric acid, ascorbic acid, malic acid are mostly insoluble in water. When added to water these calcium salts, either immediately or shortly thereafter will separate out of the solution.

Calcium has been used in the treatment and prevention of osteoporosis. However, none of the references of which Applicant is aware discloses the use, requirement or inclusion of phosphorus in required daily amounts as an equally important mineral for the prevention of osteoporosis.

It is desirable to provide a formulation of solubilized hydroxyapatite (calcium phosphate) and zinc citrate in aqueous solution which can be bottled, containing the Required Dietary Allowance of fully bioavailable calcium, phosphorus and zinc (when present) in easily consumable and palatable quantities.

### SUMMARY OF THE INVENTION

The present invention relates to providing completely solubilized and bioavailable bone mineral calcium phosphate (hydroxyapatite) and zinc citrate in aqueous solution and the methods of producing and delivering the same. Hydroxyapatite, commonly referred to as calcium phosphate, constitutes the mineral portion of the bone and is a therapeutically important mineral in bones. Hydroxyapatite is critical in maintaining bone density and strength and to prevent osteoporosis. More particularly, the present invention provides completely solubilized hydroxyapatite (calcium phosphate) and zinc citrate, in a clear water beverage from which calcium, phosphorus and zinc all in ionized form, are completely bioavailable immediately after ingestion. This obviates the necessity and time-consuming steps of disintegration and complete dissolution that must first occur from conventional solid dosage supplements or the complete dissolution of conventional powdered calcium compounds from beverages because the body will only absorb calcium and other minerals in completely dissolved form.

Bones are composed of both calcium and phosphorus. These minerals are present in the form called hydroxapatite, also known as calcium phosphate. Hydroxyapatite gives bones strength and rigidity. When the body draws calcium from the bones into the blood for other functions performed by calcium, described above it must be replenished. If not done on a continuous basis, bones weaken which leads to low bone mass and fractures. Conventional supplements are available that supply calcium. Due to limited solubility of these supplements, only about one-third of the elemental calcium contained therein dissolves into ionic form that can be absorbed. This leaves a continuing deficiency of calcium in the body. Additionally, little or no phosphorus is provided by these supplements leaving the bones vulnerable to weakness and fragility. The present invention provides ingredients, the methods of processing and delivery of completely solubilized and bioavailable hydroxyapatite (calcium phosphate) and optionally zinc citrate to help keep bones strong and healthy.

An additional and unexpected benefit of the present invention is the management of body weight. It is believed that the weight control affect of the present invention may be due to availability of fully solubilized and absorbable calcium which is not available from supplements to the same extent.

In an alternate embodiment, a composition of powdered ingredients of the present invention can be consumed by adding the powder to commercially available aqueous beverages. The present invention preferably is used per se in aqueous solution to which, after completion of an effervescent reaction, has been added suitable flavor(s), sweetener(s), acidulent(s) and preservatives. One or more water soluble vitamins, plus vitamin D, folic acid; herbal ingredients and/or extracts thereof can also be added. The addition of some of these additional ingredients imparts some turbidity to the otherwise clear aqueous solution.

Preservatives can be added to prevent microbiological growth but more preferably the aqueous solution is sterilized by heating. Colorants can be added to match the flavor or for aesthetic reasons. It is however, preferred to retain the natural color of the aqueous beverage.

The present invention also provides for combining stoichiometric ratios zinc carbonate and glycine citrate and adding to a proper amount of water, such as 16 fluid ounces of water. The aqueous solution resulting from the effervescent reaction, contains completely solubilized zinc citrate and glycine.

Definitions

As used herein, the term “flavors” includes both fruit and botanical flavors. The term “fruit flavors” refers to those flavors derived from the edible reproductive part of a seed plant, especially one having a sweet pulp associated with the seed. Also included within the term “fruit flavors” are synthetically prepared flavors made to simulate fruit flavors derived from natural sources. The term “botanical flavors” refers to flavors derived from parts of a plant other than the fruit, i.e., derived from beans, nuts, bark, roots and leaves. Also included within the term “botanical flavors” are synthetically prepared flavors made to simulate botanical flavors derived from natural sources. Examples of such flavors include cocoa, chocolate, vanilla, coffee, cola, tea and the like. Botanical flavors can be derived from natural sources such as essential oils and extracts, or can be synthetically prepared.

As used herein, the term “sweeteners” includes both natural and artificial sweeteners. Sweeteners include, but are not limited to, sucralose, acesulfame potassium, aspartame, saccharin, sucrose, glucose, fructose, high fructose corn syrup, invert sugars, sugar alcohols including sorbitol, mannitol and mixtures thereof.

As used herein, the term “acidulents” includes, but is not limited to, citric acid, lactic acid, malic acid, sodium citrate, potassium citrate.

As used herein, the term “preservatives/antimicrobial agents” includes, but is not limited to sodium benzoate, potassium benzoate, benzoic acid, ethylparaben, methylparaben, propylparaben, sorbic acid.

As used herein, the term “herbal ingredients” includes, but is not limited to Echinacea, goldenseal, soy, teas, citrus aurantium and/or extracts thereof.

### DETAILED DESCRIPTION OF THE INVENTION

The invention relates to an aqueous beverage for bone health and prevention or treating osteoporosis, to processes therefor and a composition of powdered ingredients for preparing an aqueous beverage.

The reaction of acidic compositions, hereinafter referred to as the “acid factor,” with bicarbonate or carbonate-containing compositions, hereinafter referred to as the “carbonate factor,” in an aqueous environment, such as a solution, to produce or release carbon dioxide is well known in the art and will hereinafter be referred to as an “effervescent reaction.” Products that undergo the effervescent reaction upon use normally comprise a dry, solid mixture of an acid factor and a carbonate factor, the mixture being hereinafter referred to as an “effervescent composition.” The acid factor and the carbonate factor in the effervescent compositions are normally dry solids and are water soluble, at least in the presence of each other. Additionally, the acid and carbonate factors utilized must be compatible with their intended use, i.e., they must be physiologically acceptable.

An effervescent composition of calcium carbonate, glycine phosphate and glycine citrate provides an aqueous beverage for bone health and preventing or treating osteoporosis upon adding the effervescent composition to a proper amount of water. The effervescent composition causes an effervescent reaction when added to water. Upon completion of the effervescent reaction, the aqueous beverage contains completely solubilized and bioavailable calcium phosphate, calcium citrate and glycine.

Optionally, the effervescent composition can include zinc carbonate. Upon completion of the effervescent reaction, the aqueous beverage also contains completely solubilized and bioavailable zinc citrate.

The calcium component of the present invention is derived from calcium carbonate. The phosphorus moiety comes from glycine phosphate (phosphoglycine). Optionally, zinc is obtained from zinc carbonate. Glycine citrate (citroglycine) is added not only as a critical reactant but also to aid complete solubilization of calcium carbonate, calcium citrate, zinc carbonate and zinc citrate. Calcium citrate and optionally, zinc citrate are reaction products, along with calcium phosphate (hydroxyapatite), glycine, carbon dioxide and water.

The inclusion of zinc carbonate as a reactant or zinc citrate as a reaction product in the aqueous solution of this invention is not needed to enhance solubility of calcium carbonate or enhance bioavailability or stability of the solubilized hydroxyapatite (calcium phosphate). The mineral zinc imparts its own therapeutic properties. The use of zinc is therefore optional.

Stoichiometric ratios of the effervescent composition of calcium carbonate, glycine citrate and glycine phosphate and optionally zinc carbonate, are added to a proper amount of water, such as 20 fluid ounces of water at room temperature in a suitable stainless steel or glass vessel with moderate mechanical stirring. Water can be tap water or it can be purified, deionized, carbonated or distilled. More preferably, reverse osmosis purified water is used. The effervescent reaction begins which lasts for 30-60 minutes. Mixing at moderate speed is maintained and can be stopped anytime during this time period. More preferably, mixing is maintained for 45 minutes. Stoichiometric ratios of the reactants are calculated to provide 500 mg of elemental calcium, 350 mg of elemental phosphorus and 7.5 mg of elemental zinc, when present, in each 20 fluid ounces of the aqueous solution of the present invention.

Next, sweetener(s), acidulents(s) and other nutritional and/or herbal ingredients, when used are added. Mixing is continued at moderate speed for 15-30 minutes, more preferably for 20 minutes. Flavor(s) are then added and mixing at moderate speed is continued preferably for 10 minutes.

The aqueous solution of the present invention containing completely solubilized and bioavailable hydroxyapatite (calcium phosphate) and optionally zinc citrate preferably provides 50% of the Recommended Daily Intake (RDI) of calcium, 35% of phosphorus and optionally 50% of zinc in each 20 fluid ounce serving. Two servings supply 100% of the RDI of calcium, 70% of phosphorus and 100% of zinc. Serving size can be reduced or increased. Serving sizes of 12 fluid ounces and up to 24 fluid ounces are common and acceptable. The preferred serving size of the present invention is 20 fluid ounces. Recommended Daily Intake of calcium and phosphorus and optionally zinc can be reduced by up to 50% or increased by up to 50% for the preferred serving size. Reducing the RDI would require more servings to be consumed per day. However, consumers may be averse to drinking more than two 20 fluid ounce servings daily. Not consuming the full servings would leave consumers deficient in the essential bone building minerals and thus negate the advantage inherent in the aqueous beverage of the present invention. Increasing the RDI of these minerals in the preferred serving size renders the aqueous beverage less palatable and thus less acceptable.

The aqueous solution of the present invention containing 50% RDI of calcium, 35% RDI of phosphorus and optionally 50% RDI of zinc in each 20 fluid ounce serving and after addition of other ingredients and further treatment as described above can be packaged in larger volume containers for ease of handling and cost savings. Containers of half gallon and one gallon size may be appropriate, bearing labels specifying directions for use as necessary.

The present invention also provides for combining stoichiometric ratios of zinc carbonate and glycine citrate and adding to a proper amount of water, such as 16 fluid ounces of water. The aqueous solution resulting from the effervescent reaction, contains completely solubilized zinc citrate and glycine.

Stoichiometric ratios are calculated to provide 100% of the RDI of zinc which is 15 mg. Serving size may vary between 12 and 20 fluid ounces. Preferred serving size is 16 fluid ounces. To this aqueous solution are added flavor(s), sweetener(s) and acidulent(s). Other ingredients that may be added, methods of processing and packaging are same as above.

The aqueous beverage containing completely solubilized hydroxyapatite (calcium phospate), optionally zinc citrate and other ingredients can be sterilized. Sterilization can be accomplished by the incorporation of preservatives/antimicrobial agents or heat. More preferably, sterilization is accomplished by heating. Heating can be accomplished in a heat exchanger or jacketed steam kettles. More preferably, heat exchanger is used to provide for faster and continuous processing. The aqueous solution is heated to between 140° F. and 200° F. More preferably to 195° F. and maintained at this temperature for 20-60 seconds, but more preferably for 30 seconds. The aqueous beverage is allowed to cool to 186° F. and bottled at this temperature. The pH of the aqueous beverage is in the range of 2.8 and 4.8. Prior to heating, the aqueous beverage of the present invention can be carbonated. More preferably, the aqueous beverage is maintained in the still, non-carbonated form.

When preservatives/antimicrobial agents are used, the heating step is by-passed. Preservatives/antimicrobial agents are added along with flavor(s), sweetener(s), acidulent(s) and other ingredients and the process continued as described above.

The aqueous beverage of the present invention containing completely solubilized and bioavailable hydroxyapatite (calcium phosphate) and optionally zinc citrate in flavored, sweetened, palatable form can be packaged in tightly capped polyethylene terephthalate (PET) or glass bottles or jugs but more preferably in PET bottles/jugs. The caps (lids) have tamper-evident rings that detach when bottles/jugs are opened. PET bottles/jugs can be clear or tinted.

Processed and packaged by the methods of the present invention, the aqueous beverage of the present invention containing completely solubilized and bioavailable hydroxyapatite (calcium phosphate), and optionally zinc citrate and other ingredients has been found to be stable with no change in taste, appearance, chemical or physical properties after two years.

In an alternate embodiment, the effervescent composition of the present invention can be used in powder form. In this embodiment, the ingredients used in the effervescent composition of calcium carbonate, glycine phosphate (phosphoglycine), glycine citrate (citroglycine), and optionally zinc citrate in their stoichiometric ratios, flavor(s), sweetener(s), acidulents(s) and other ingredients are mixed together and packaged in sachets for reconstitution. The stoichiometric ratios will yield the same RDI of each mineral as if they were to be used in water. The contents of the sachets are added to a predetermined amount of water, such as 20 fluid ounces of commercially available aqueous beverages. The aqueous beverages used for reconstitution of the sachet contents include, but are not limited to Seven-Up®, Seltzer Waters, Sprite®, plain bottled water and ice tea. The sachet contents can be added to less than 20 fluid ounces or more than 20 fluid ounces of the reconstitution beverage. Adding to less than 20 fluid ounces appreciably altered the taste and flavor which were not acceptable. Adding to more than 20 fluid ounces was acceptable but required that the entire volume be consumed in one day to derive the intended bone health benefit. The preferred volume of the reconstitution beverage is 20 fluid ounces.

After the sachet contents are added to a container of the aqueous beverage, the container can be closed and shaken lightly for 30 seconds. Within a minute, the cap can be removed to allow escape of the evolved carbon dioxide gas. The resulting beverage now also contains completely solubilized and bioavailable hydroxyapatite (calcium phosphate) and optionally zinc and is ready for consumption as such or after refrigeration.

The effervescent composition of the present invention can also be combined with commercially available powdered drink mixes prior to their reconstitution in water. The powdered drink mixes utilized for combining with the effervescent composition of the present invention include, but are not limited to, Kool-Aid®, Crystal Light®, Ice Tea To-Go® and Green Tea To-Go®, following the reconstitution directions on the packages of these powdered drink mixes.

In both cases above of reconstitution of the sachet contents of the present invention in commercial aqueous beverages or combining with other commercially available powdered drink mixes, the flavor(s), sweetener(s) and acidulents(s) concentrations in the sachet contents may need to be changed. More preferably, the amounts of these additives may need to be reduced as commercially available aqueous beverages and powdered drink mixes may already contain these additives in adequate amounts.

### EXAMPLE

### Comparative Bioavailability and Effect on Bone Density

A laboratory study was conducted to compare the relative affects of the aqueous beverage of this invention and calcium carbonate powder on bone development in young, growing rats. Ten male weanling Sprague-Dawley derived albino rats weighing 70-80 g were used in each group. All animals were fed the same basal diet. Control group received calcium from calcium carbonate powder incorporated in the diet. Drinking water was provided ad-libitum. Test group was provided the aqueous beverage of this invention containing completely solubilized hydroxyapatite (calcium phosphate) and calculated to contain the same amount of elemental calcium as the control group. The calculated volume was lower than the volume of drinking water consumed by the control group. The difference was made up by mixing drinking water with it. Food consumption, volume of drinking water, volume of the aqueous beverage of this invention and animal weights were recorded daily. At the end of 30 days the animals were sacrificed and both femurs from each animal were removed for evaluation. Results show that bone mineral density, tensile strength, femur ash, femur calcium and phosphorus were all much higher for the test group compared to the control. Bone density and bone strength numbers were 2.5-3 times greater for test group than the control. On day 30, the individual mean body weight gain for the test group was almost 15% lower.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. An aqueous beverage comprising an effervescent composition comprising:
calcium carbonate, glycine phosphate, glycine citrate, optionally zinc carbonate; and
water.

2. The aqueous beverage of claim 1 wherein ingredients of said effervescent composition are used in stoichiometric ratios to provide 500 mg of elemental calcium, 350 mg of elemental phosphorus and optionally 7.5 mg of elemental zinc in a 20 fluid ounce serving of said beverage.

3. The aqueous beverage of claim 1 wherein an effervescent reaction is caused by addition of said calcium carbonate, glycine phosphate, glycine citrate and optionally zinc carbonate which are present in stoichiometric ratios to said water.

4. The aqueous beverage of claim 1 wherein solubilized calcium phosphate, calcium citrate, glycine and optionally zinc citrate are produced upon completion of an effervescent reaction.

5. The aqueous beverage of claim 1 further comprising one or more flavor, sweetener or acidulent.

6. The aqueous beverage of claim 1 further comprising one or more vitamins, folic acid, herbal ingredients or extracts thereof.

7. An aqueous beverage comprising an effervescent composition comprising zinc carbonate and glycine citrate; and
water.

8. The aqueous beverage of claim 7 wherein the ingredients of said effervescent composition are used in stoichiometric ratios to provide 15 mg of elemental zinc in a 16 fluid ounce serving of said beverage.

9. The aqueous beverage of claim 7 wherein the addition of stoichiometric ratios of zinc carbonate and glycine citrate to water at room temperature causes an effervescent reaction.

10. The aqueous beverage of claim 7 wherein completely solubilized zinc citrate and glycine are produced upon completion of an effervescent reaction.

11. The aqueous beverage of claim 7 further comprising one or more flavor, sweetener or acidulent.

12. The aqueous beverage of claim 1 further comprising one or more vitamins, folic acid, herbal ingredients or extracts thereof.

13. The aqueous beverage of claim 5 wherein the completely solubilized calcium phosphate remains stable and in solution for at least two years.

14. The aqueous beverage of claim 11 wherein the completely solubilized zinc citrate has remained stable and in solution for at least three years.

15. An aqueous beverage for delivery of a therapeutically effective amount of solubilized calcium phosphate to a mammal comprising an effervescent composition comprising calcium carbonate, glycine phosphate, glycine citrate, and optionally zinc carbonate; and
water wherein said solubilized calcium phosphate is produced upon completion of an effervescent reaction.

16. A process for preparing an aqueous beverage comprising:
a) mixing an effervescent composition comprising calcium carbonate, glycine phosphate, glycine citrate, water and optionally zinc carbonate with water.

17. The process of claim 16 wherein said effervescent composition is continuously mixed after step a) for a period to complete an effervescent reaction.

18. The process of claim 16 further comprising the step of heating said aqueous beverage for sterilization of said aqueous beverage.

19. A solid effervescent composition of powdered ingredients, said effervescent composition comprising calcium carbonate, glycine phosphate, glycine citrate and optionally zinc carbonate.

20. The effervescent composition of claim 19 wherein the said ingredients are used in stoichiometric ratios to provide 500 mg of elemental calcium, 350 mg of elemental phosphorus and optionally 7.5 mg of elemental zinc.

21. The effervescent composition of claim 19 further comprising one or more flavor, sweetener or acidulent.

22. The effervescent composition of claim 19 which is used for reconstitution in an aqueous beverage.

23. The effervescent composition of claim 19 which is used for combination with a powdered drink mix.

24. The effervescent composition of claim 19 for preparing an aqueous beverage.
